(19) United States
(12) Patent Application Publication
(10) Pub. No.: US 2011/0222163 A1
(43) Pub. Date: Sep. 15, 2011

(54) VARIFOCAL LENS AND LIQUID FILLING METHOD FOR MANUFACTURING SAME

(76) Inventor: Yasutoshi HIRABAYASHI, Ashigarakami-gun (JP)

(21) Appl. No.: 13/047,494

(22) Filed: Mar. 14, 2011

(30) Foreign Application Priority Data
Mar. 12, 2010 (JP) 2010-056148

(51) Int. Cl. G02B 3/14; B65B 3/04

(52) U.S. Cl. 359/666; 141/1

(57) ABSTRACT

A varifocal lens which uses an interface between a first fluid and a second fluid that are mutually immiscible, as a light refracting surface, includes: a sealed vessel in which a first chamber into which the first fluid is filled is connected via an opening to a second chamber into which the second fluid is filled; and an elastic deformation section which is provided in elastically deformable fashion in a portion of a partition wall that divides the first chamber and the second chamber in the sealed vessel and which deforms in contact with both the first fluid filled into the first chamber and the second fluid filled into the second chamber, wherein: a lens section having the interface is formed in the opening, and a focal length of the lens section is changed by causing the interface to deform through altering volumes of the first chamber and the second chamber in mutually opposite directions by deformation of the elastic deformation section.

### BACKGROUND OF THE INVENTION

1. Field of the Invention

The present invention relates to a varifocal lens of which the focal length can be varied and controlled, and in particular, to a structure of a small varifocal lens suited to high-speed response which uses a liquid interface as a refractive surface, and to a liquid filling method employed when manufacturing the varifocal lens.

2. Description of the Related Art

Since a general varifocal lens moves the position of a lens which constitutes an optical system and therefore requires a stroke corresponding to the amount of variation of the focal length, it takes time to move the lens and is restricted in terms of the speed of response. From a view point of measuring external information, for instance, in a vision sensor, or the like, the response speed of a varifocal lens which moves the lens itself is very slow. Since the response speed of the optical system is extremely slow compared to the time required for image capture in an imaging element, or the image processing time, the optical system presents a bottle neck in the overall system, and therefore high-speed response is demanded in a varifocal lens.

Japanese Patent Application Publication No. 2009-217249 and “Milliseconds High-Speed Liquid Variable-Focus Lens for Robot Vision”, by Hiromasa OKU (Univ. of Tokyo), Yasuaki MONNAI (Univ. of Tokyo), Masatoshi ISHIKAWA (Univ. of Tokyo), 26^{th} Annual Conference of the Robotics Society of Japan (9-11 Sep. 2008), RSJ2008AC3I1-03, disclose a “dynamorph lens” in which an interface between mutually immiscible liquids (a liquid interface forming a spherical surface) is used as a light refracting surface, and the interface between the liquids is controlled by the pressure of the liquids. This is achieved by designing the surface area which is displaced by a laminated type PZT actuator so be several ten to several hundred times the surface area of the lens, and causing the lens to deform by means of slight displacement of the PZT. Moreover, by manufacturing the liquid interface which serves as a lens with high accuracy by photolithography, high resolution can be achieved. By this method, high response of 2 ms (500 Hz) and high resolution of 49 cycles/mm can be obtained.

Japanese Patent Application Publication No. 2008-152090 discloses a composition for a varifocal liquid lens using liquid (fluid) in which a micropump is used in order to produce a large change in the focal length. One embodiment of Japanese Patent Application Publication No. 2008-152090 discloses a lens which employs a piezoactuator having a dynamorph structure using a transversal piezoelectric effect, the lens being compact in size and having a large distance of movement of the focal point.

The liquid which constitutes the varifocal lens proposed in Japanese Patent Application Publication No. 2009-217249, etc. is not compressible, and therefore the liquid requires a space to be able to move in accordance with the deformation volume of the lens when the refractive surface (interface) is changed. Therefore, in Japanese Patent Application Publication No. 2009-217249, through holes are formed in the upper portion of a second space which accommodates a second medium (the portion in the upper left-hand portion of FIG. 2 in Japanese Patent Application Publication No. 2009-217249). According to a composition of this kind, liquid may leak out when the apparatus is moved and liquid may evaporate through the aperture, because the liquid (second medium) is not sealed.

The varifocal liquid lens apparatus disclosed in Japanese Patent Application Publication No. 2008-152090 has a first micro pump which contacts a first fluid and a second micro pump which contacts a second fluid (see FIG. 6 in Japanese Patent Application Publication No. 2008-152090), and the change in the volumes of the first fluid and the second fluid can be absorbed by these micro pumps. Therefore, it is possible to set the fluid to a sealed state inside a cylinder.

However, according to the composition in Japanese Patent Application Publication No. 2008-152090, two micro-pumps are required, and therefore the overall size of the lens apparatus becomes large.

Furthermore, since the second micro pump serves as a damper or a spring with respect to change in the volume of the first micro pump, then residual vibration may arise at the liquid interface which constitutes the lens. In order to eliminate residual vibration at the liquid interface which constitutes the lens, the amount of change in the second micro pump is required to be controlled actively so as to absorb the change in the volume of the first micro pump, and such control is complicated.

### SUMMARY OF THE INVENTION

The present invention has been contrived with the foregoing circumstances in view, an object thereof being to provide a varifocal lens whereby it is possible to prevent external leaking of liquid from inside the lens, even when the lens is moved, to prevent the liquid inside the lens from coming into contact with the air and evaporating, and to suppress residual vibration of the liquid lens (interface), and it is a further object of the invention to provide a liquid filling method for use in manufacturing the varifocal lens.

In order to attain an object described above, one aspect of the present invention is directed to a varifocal lens which uses an interface between a first fluid and a second fluid that are mutually immiscible, as a light refracting surface, the varifocal lens comprising: a sealed vessel in which a first chamber into which the first fluid is filled is connected via an opening to a second chamber into which the second fluid is filled; and an elastic deformation section which is provided in elastically deformable fashion in a portion of a partition wall that divides the first chamber and the second chamber in the sealed vessel and which deforms in contact with both the first fluid filled into the first chamber and the second fluid filled into the second chamber, wherein: a lens section having the interface is formed in the opening, and a focal length of the lens section is changed by causing the interface to deform through altering volumes of the first chamber and the second chamber in mutually opposite directions by deformation of the elastic deformation section.

According to this aspect of the invention, since the first fluid and the second fluid are enclosed inside a sealed container, then even if the varifocal lens is moved, there is no leakage of fluid to the exterior from inside the lens. Furthermore, according to this aspect of the invention, it is possible to prevent the fluid from evaporating due to the contact with the external air. Moreover, since the elastic deformation section of this aspect of the present invention makes contact with both the first fluid in the first chamber and the second fluid in the second chamber, then the deformation of the elastic deformation section results in a mutually complementary relationship between the volume change of the first chamber and the second chamber. More specifically, if the volume of the first chamber decreases due to the deformation of the elastic deformation section, then the volume of the second chamber increases, and conversely, if the volume of the first chamber increases, then the volume of the second chamber decreases. Based on the mutually opposite volume changes of the two chambers, it is possible to change the shape of the interface between the first fluid and the second fluid, which contact each other via the opening in the sealed vessel, and it is also possible to suppress residual vibration of the fluid lens.

The fluids used in the varifocal lens according to this aspect of the present invention include, in addition to generic single-phase liquids, an emulsion which is a two-phase mixture of mutually immiscible liquids, a suspension of insoluble solid micro-particles dispersed in a liquid, and compositions having fluid properties similar to a liquid, such as a slurry, gel, sol, micro-powder material, and the like.

A composition which uses, as a refractive surface of a lens, a liquid-liquid interface of two substances of different types having different refractive indices where the substances of two types are in mutual contact in a state of separation into two layers, has higher stability of the interface shape compared to a case using an air-liquid interface in which a gas and a liquid are in mutual contact.

Desirably, the elastic deformation section has a composition in which a drive section producing force to deform a diaphragm provided in a portion of the partition wall is provided with the diaphragm.

It is desirable to use an actuator having a diaphragm structure in the elastic deformation section.

Desirably, the drive section is a piezoelectric element.

The piezoelectric element has a composition in which a piezoelectric body is sandwiched between electrodes. A piezoelectric actuator of a diaphragm type in which a piezoelectric element is layered on a diaphragm is suitable as the elastic deformation section. Furthermore, it is also possible to use an electrostatic actuator, for example, instead of a piezoelectric actuator.

Desirably, of the first fluid and the second fluid, the fluid contacting with the piezoelectric element is an oil-based fluid.

Since the piezoelectric body has properties which deteriorate upon contact with water, it is possible to improve the durability of the piezoelectric element by using an oil-based fluid as the fluid which makes contact with the piezoelectric body.

Desirably, the diaphragm deforms due to deformation in a d31 direction of a piezoelectric body sandwiched between electrodes of the piezoelectric element.

The piezoelectric element can be provided on either the first chamber side face or the second chamber side face of the diaphragm. It is also possible to adopt a mode in which a piezoelectric element is provided on both faces of the diaphragm (on both sides across the diaphragm).

Desirably, the diaphragm is made of silicon (Si), or a combination of silicon dioxide (SiO₂) and silicon (Si).

According to this aspect of the invention, by employing semiconductor manufacturing technology using a Si wafer or SOI wafer, it is possible to manufacture a fine actuator device.

Desirably, the sealed vessel includes: a first chamber structure having a first recess section forming a space of the first chamber, a second chamber structure having a second recess section forming a space of the second chamber, and a partition plate which has the opening and is bonded between the first chamber structure and the second chamber structure so as to cover a side of the first recess section of the first chamber structure and a side of the second recess section of the second chamber structure to serve as the partition wall.

It is possible to obtain a sealed vessel by bonding the first chamber structure and the second chamber structure together in such a manner that the first recess section and the second recess section are mutually facing via a partition plate.

Desirably, the elastic deformation section having a diaphragm structure is provided in a portion of the partition plate.

Desirably, the sealed vessel is provided with an inlet port for introducing the first fluid and the second fluid into the sealed vessel, an outlet port for discharging the first fluid and the second fluid from the sealed vessel, a first valve which opens and closes the inlet port, and a second valve which opens and closes the outlet port.

According to this aspect of the invention, it is possible to introduce the first fluid and the second fluid into the sealed vessel and to discharge the fluids from the vessel, and by closing the first valve and the second valve after filling the first fluid into the first chamber and the second fluid into the second chamber, it is possible to seal the fluids hermetically inside the vessel.

In order to attain an object described above, another aspect of the present invention is directed to a liquid filling method for manufacturing the varifocal lens, comprising the steps of: introducing a first liquid corresponding to the first fluid into the sealed vessel via the inlet port so as to fill the first liquid into both the first chamber and the second chamber; and discharging the first liquid via the outlet port while introducing a second liquid corresponding to the second fluid into the sealed vessel via the inlet port so as to replace the first liquid in one of the first chamber and the second chamber with the second liquid.

According to this liquid filling method, it is possible to fill the first chamber with the first liquid and to fill the second chamber with the second liquid, without any air remaining inside the sealed vessel.

According to the present invention, it is possible to prevent external leaking or evaporation of liquid, or the like, by means of a sealed structure. By this means, it is possible to obtain a lens which is insusceptible to the attitude of the lens or by external impacts.

Furthermore, it is also possible to suppress residual vibration which is a problem in the related art compositions, and high-speed response can be achieved.

### BRIEF DESCRIPTION OF THE DRAWINGS

A preferred embodiment of this invention as well as other objects and benefits thereof, will be explained in the following with reference to the accompanying drawings, in which like reference characters designate the same or similar parts throughout the figures and wherein:

FIG. 1 is a cross-sectional diagram showing a structure of a varifocal lens relating to an embodiment of the present invention;

FIG. 2 is a cross-sectional diagram showing an example of the composition of a piezoelectric actuator;

FIG. 3 is a cross-sectional diagram showing an example of the composition of a piezoelectric actuator manufactured using an SOI substrate;

FIGS. 4A to 4D are illustrative diagrams showing steps of a method of filling liquid of a varifocal lens relating to an embodiment of the present invention; and

FIG. 5 is a plan view perspective diagram of a varifocal lens relating to an embodiment of the present invention.

### DESCRIPTION OF THE PREFERRED EMBODIMENTS

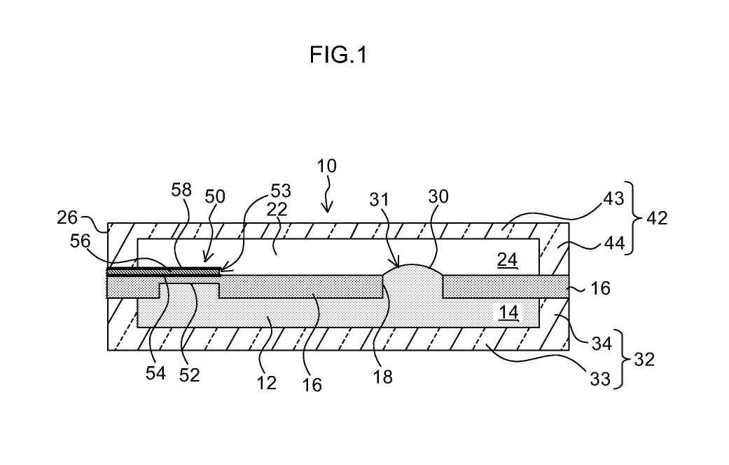

FIG. 1 is a cross-sectional diagram showing a structure of a varifocal lens relating to an embodiment of the present invention. This varifocal lens 10 has a first liquid chamber 14 which accommodates a first liquid 12 (corresponding to a “first liquid”) and a second liquid chamber 24 which accommodates a second liquid 22 (corresponding to a “second liquid”). A circular opening 18 is formed in a partition plate 16 which divides (demarcates) the first liquid chamber 14 from the second liquid chamber 24, and a sealed vessel 26 structure is obtained in which the first liquid chamber 14 and the second liquid chamber 24 are mutually connected via the opening 18.

The first liquid 12 which is filled into the first liquid chamber 14 and the second liquid 22 which is filled into the second liquid chamber 24 have respectively different refractive indices, and are mutually immiscible liquids. These two types of liquid (12, 22) make contact with each other at the location of the opening 18 in the partition plate 16, and a two-liquid interface 30 is formed at this opening 18. This interface 30 forms a refractive surface which refracts light, and serves (functions) as a lens. More specifically, an interface 30 between the first liquid 12 and the second liquid 22 is formed at the opening 18, and a lens section 31 having this interface 30 as a refractive surface is formed. If used as a convex lens, the refractive index of the lower liquid (the first liquid) is greater.

In FIG. 1, the first chamber structure 32 which demarcates a bottom face and side faces of the first liquid chamber 14 includes a bottom plate member 33 which seals the bottom face of the first liquid chamber 14 and a side wall member 34 which covers the side faces of the first liquid chamber 14. Similarly, the second chamber structure 42 which demarcates a ceiling face and side faces of the second liquid chamber 24 includes a ceiling plate member 43 which seals the ceiling face of the second liquid chamber 24 and a side wall member 44 which covers the side faces of the second liquid chamber 24. The bottom plate member 33 and the ceiling plate member 43 are both members which ensure sealing properties for enclosing the liquid, as well as having light transmitting properties that allow light to enter into the lens section 31 and exit to the exterior after having passed through the lens section 31.

The side wall members 34, 44 may be members having light transmitting properties (transparent members) or may be members not having light transmitting properties (opaque members). In the case of the present embodiment, the side wall member 34 is made of a transparent glass material which is integrated with the base plate member 33. Furthermore, the side wall member 44 is made of a transparent glass material which is integrated with the ceiling plate member 43. For example, it is possible to obtain the first chamber structure 32 by forming a recess section (corresponding to the “first recess section”) which forms a space for the first liquid chamber 14 by cutting out (grinding down) one surface of a glass substrate. Similarly, it is possible to obtain the second chamber structure 42 by forming a recess section (corresponding to the “second recess section”) which forms a space for the second liquid chamber 24 by cutting out (grinding down) one surface of a glass substrate.

By coupling the first chamber structure 32 and the second chamber structure 42 via the partition plate 16, a sealed vessel 26 having a first liquid chamber 14 and a second liquid chamber 24 is formed.

A piezoelectric actuator 50 having a diaphragm structure is provided as a device for changing the shape of the lens section 31 (in other words, the shape of the interface 30), in a portion of the partition plate 16 which is disposed inside the sealed vessel 26. This portion of the piezoelectric actuator 50 corresponds to an “elastic deformation section”. The piezoelectric actuator 50 has a structure in which a piezoelectric element 53 (corresponding to a “drive section”) is formed on top of a diaphragm 52. In other words, the piezoelectric actuator 50 has a structure in which a lower electrode 54, a piezoelectric film 56 and an upper electrode 58 are layered in this order on a diaphragm 52. The piezoelectric element 53 is formed by a layer structure in which a piezoelectric film 56 is interposed between the lower electrode 54 and the upper electrode 58. The piezoelectric element 53 can be manufactured by thin film forming technology, such as bonding of bulk ceramic, sputtering, a sol-gel method, or the like. Various methods can be used as a method for forming a piezoelectric film on the diaphragm, but sputtering and a sol-gel method are desirable from the viewpoint of being able to form a film at low temperature in order to reduce stress and being able to form a thin film of not less than several μm thickness, which has a high drive torque.

In FIG. 1, in order to simplify the description, the film thickness ratios are depicted differently to the actual ratios, in order to emphasize the visual appearance of each layer. To give one example of the implemented dimensions, the film thickness of the piezoelectric film 56 is 2 to 3 μm, and the film thickness of each electrode (54, 58) is 0.2 μm. Therefore, the surface undulation caused by the layered structure in which a piezoelectric element 53 is formed on top of the diaphragm 52 is extremely small.

The first liquid chamber 14 side of the diaphragm 52 contacts with the first liquid 12. On the other hand, the side of the diaphragm 52 on which the piezoelectric element 53 is formed (the upper surface side in FIG. 1) contacts the second liquid 22 in the second liquid chamber 24. The first liquid 12 and the second liquid 22 are sealed completely inside the lens (inside the sealed vessel 26), and therefore it is possible to prevent evaporation of the liquid due to contact with the air, without the liquid leaking to the exterior. Moreover, according to the structure of the present embodiment, looking in particular at the portion of the diaphragm 52, the volume of the first liquid chamber 14 is decreased in accordance with the removed volume produced by the bending and deformation of the diaphragm 52 in the downward direction in FIG. 1, and the volume of the second liquid chamber 24 is increased on the upper side of the diaphragm 52 in accordance with the decrease in volume of the first liquid chamber 14. In other words, if the amount of volume change of the first liquid chamber 14 due to displacement of the diaphragm 52 is ΔV1, and the amount of volume change of the second liquid chamber 24 is ΔV2, a volume increase being indicated by a “+” symbol and a volume decrease being indicated by a “−” symbol, then the relationship therebetween is ΔV1=−ΔV2.

In this case, in the lens section 31, the first liquid 12 presses the interface 30 upward in accordance with the decrease in the volume of the first liquid chamber 14 and the second liquid 22 is retracted accordingly. In this way, it is possible to change the shape (curvature) of the interface 30 by changing the diaphragm 52 in such a manner that the focal length of the lens section 31 can be changed. Furthermore, as described above, if the focal length is changed, then the interface 30 of the lens section 31 can be driven in a resistance-free state, and therefore residual vibration of the lens section 31 can be suppressed. By this means, it becomes possible to achieve high-speed response in the lens. Furthermore, the interface 30 is close to an ideal spherical surface shape due to surface tension, and hence a lens having high resolving power is obtained.

### Compositional Example of Piezoelectric Actuator

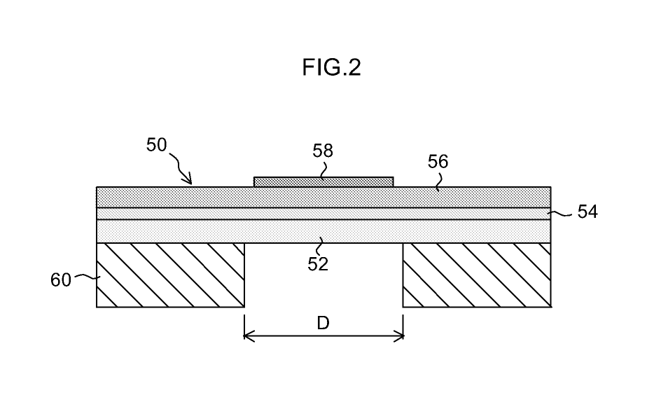

FIG. 2 shows an example of the composition of a piezoelectric actuator 50. For the device which causes the diaphragm 52 to deform elastically, an actuator employing a piezoelectric element such as that shown in FIG. 2 is used. As shown in FIG. 2, this piezoelectric actuator 50 is an actuator having a diaphragm structure constituted by layering a lower electrode 54, a piezoelectric film 56 and an upper electrode 58 on top of a diaphragm 52. This actuator is a so-called unimorph type actuator in which the periphery of a movable portion of the diaphragm 52 is supported (fixed) by a supporting body 60, and the diaphragm 52 bends due to displacement of the piezoelectric film 56 in the d31 direction. The supporting body 60 can be realized by a thick portion of the partition plate 16 which is described in relation to FIG. 1.

Furthermore, in FIG. 2, the portion of the piezoelectric film where a voltage is not applied (in other words, the portion where the upper electrode 58 does not exist) is removed by etching, thus making it possible to drive the diaphragm 52 efficiently. In the present embodiment, the shape of the diaphragm 52 which forms a movable part capable of performing elastic deformation is a square shape in plan view, and the width of the opening of the supporting body 60 is expressed as D in FIG. 2 (the length of one edge of the square diaphragm).

### Example of Method of Manufacturing Varifocal Lens

Next, one example of a method of manufacturing a varifocal lens 10 relating to the present embodiment will be described. A varifocal lens according to one example of the present embodiment of the present invention was manufactured by the following steps.

### Step 1

Firstly, an SOI (Silicon On Insulator) substrate having a 10 μm-thick active layer, a 1 μm-thick oxide film and a 500 μm-thick supporting body layer was prepared, and by etching the supporting body layer, a diaphragm (reference numeral 52 in FIG. 1) constituted by the active layer and the oxide film was fabricated. Moreover, by then etching the whole of the supporting body layer, the oxide layer and the active layer to form a through hole, an opening (reference numeral 18 in FIG. 1) corresponding to the lens section (reference numeral 31 in FIG. 1) was manufactured.

The size (in plan view) of the diaphragm manufactured in this step was a 1 mm square shape (a square shape having edges of length D=1 mm), and the opening of the lens section was a circular shape having a diameter of 3 mm.

### Step 2

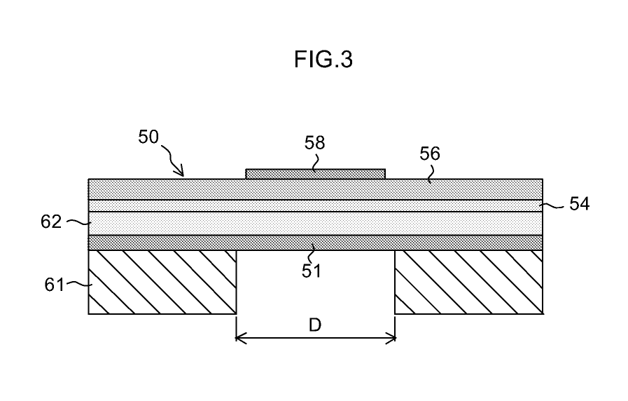

Next, a piezoelectric element was formed by depositing a lower electrode, a piezoelectric film and an upper electrode by sputtering, on top of the diaphragm, and the center of the 1 mm-square diaphragm was patterned to produce an 800 μm-square shape. FIG. 3 shows a partial enlarged diagram of a piezoelectric actuator. In FIG. 3, elements which are the same as or similar to FIG. 2 are labeled with the same reference numerals and further explanation thereof is omitted here.

In FIG. 3, reference numeral 61 represents a supporting body layer and reference numeral 51 represents an oxide film (SiO₂ film), and reference numeral 62 represents an active layer (Si layer). In this step, a “diaphragm” was formed by the layered body of the oxide film 51 and the active layer 62 corresponding to the region where the supporting body layer 61 had been removed by etching (the region which was capable of elastic deformation). The member corresponding to the partition plate 16 illustrated in FIG. 1 was obtained by means of steps 1 and 2 described above.

It is also possible to further remove the oxide film 51 so as to form a diaphragm by means of the active layer 62 only, and it is also possible to adopt a mode which uses a silicon substrate instead of an SOI substrate.

### Step 3

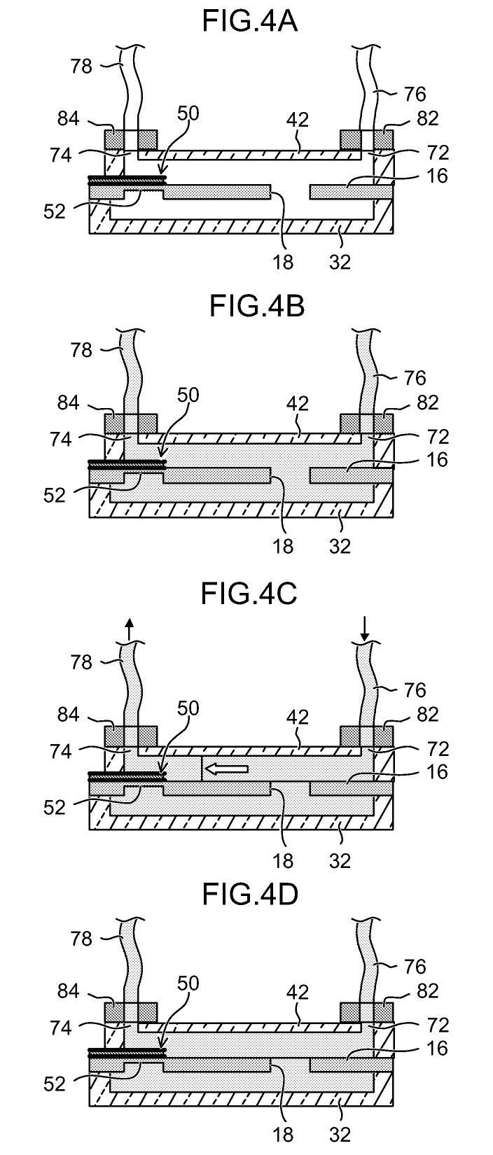

Next, glass substrates in each of which a groove (recess section) had been excavated (the first chamber structure 32 and the second chamber structure 42 shown in FIG. 1) were prepared as vessels for accommodating the first liquid 12 and the second liquid 22. Two through holes were formed in the glass vessel which accommodates the second liquid 22 (the second chamber structure 42), as an inlet port and an outlet port for filling liquid (see FIG. 4A, where reference numeral 72 denotes an inlet port and reference numeral 74 denotes an outlet port).

### Step 4

The partition plate 16 (SOI substrate) obtained in step 2 and the glass vessels (first chamber structure 32 and second chamber structure 42) prepared in step 3 were bonded together by epoxy adhesive. More specifically, an adhesive was applied to a thickness of about 2 μm on the bonding surfaces of the SOI substrate and the glass vessels, and the SOI substrate and the glass vessels were bonded together. In this step, wires for the lower electrode 54 and the upper electrode 58 were laid so as to extend to the exterior of the sealed vessel 26 which is enclosed in glass (see FIGS. 4A to 4D).

### Step 5

Next, valves 82 and 84 connected to tubes 76 and 78 along which liquid can flow were fixed by epoxy adhesive bonding, to the portions of the second chamber structure 42 corresponding to the inlet port 72 and the outlet port 74 (see FIGS. 4A to 4D). In this way, a vessel structure such as that shown in FIG. 4A was obtained. The valve 82 provided with the inlet port 72 corresponds to a “first valve”, and the valve 84 provided with the outlet port 74 corresponds to a “second valve”.

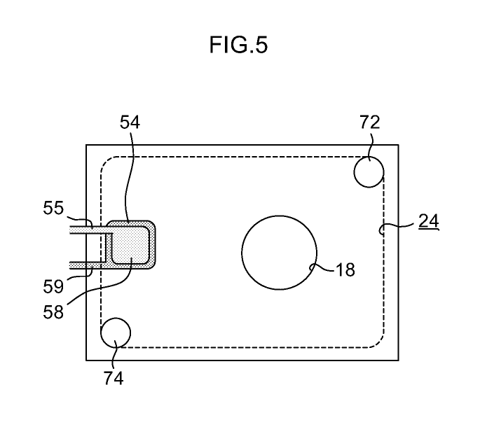

FIG. 5 shows a plan view perspective diagram for reference purposes. In FIG. 5, reference numeral 55 denotes a wiring electrode which is connected to the lower electrode 54, and reference numeral 59 denotes a wiring electrode which is connected to the upper electrode 58.

The inlet port 72 and the outlet port 74 are desirably formed in corners of a diagonal of the substantially rectangular-shaped second liquid chamber 24 when observed in plan view, as shown in FIG. 5. By adopting an arrangement of this kind, the air inside the vessel is expelled readily to the exterior when liquid is introduced.

### Liquid Filling Method

Next, the method of filling liquid is described below.

### Step 6

Firstly, pure water (specific gravity 1, refractive index 1.33) (which corresponds to a “first liquid”) was introduced from the inlet port 72 via a tube 76 in a state where both valves 82 and 84 were open, and the pure water was filled into the first liquid chamber 14 and the second liquid chamber 24 (see FIG. 4B). In this step, the pure water was filled into the vessel after being sufficiently deaerated.

### Step 7

Next, a mixed solution (specific gravity 1, refractive index 1.5) of toluene and chlorobenzene which were oil-based liquids, was introduced slowly so as not to disturb the liquid inside the vessel (FIG. 4C). The liquid (corresponding to the “second liquid”) of mixed toluene and chlorobenzene which had 44.4 wt % (weight percent) content of toluene in order to achieve a specific gravity of 1 was immiscible with pure water, and therefore, when this liquid (hereinafter, called “oil-based liquid”) was introduced into the second liquid chamber 24, the pure water that had been filled into the second liquid chamber 24 was replaced by this oil-based liquid. More specifically, the pure water which had been filled into the second liquid chamber 24 exited to the exterior from the outlet port 74 as the oil-based liquid was introduced, and was thereby replaced by the oil-based liquid. In this step, a two-liquid interface 30 was formed in the upper portion of the opening 18 (through hole).

### Step 8

As shown in FIG. 4D, when the pure water in the second liquid chamber 24 was replaced completely with oil-based liquid, the vessel was sealed by closing the valves 82, 84, in the sequence of inlet port 72 followed by outlet port 74.

### Step 9

Thereupon, the tubes 76 and 78 were removed.

The operation of the varifocal lens manufactured by the procedure described above was confirmed in the following manner.

### Operational Confirmation Experiment

A drive circuit was connected to the wiring electrodes (see reference numerals 55 and 59 in FIG. 5) extracted to the exterior of the vessel, and a 50V DC voltage was applied to the piezoelectric actuator, causing the diaphragm to deform convexly downwards in FIG. 4D and causing the interface 30 of the lens section 31 to deform convexly upwards.

The volume change amount (removed volume) of the diaphragm was measured by a laser Doppler vibrometer, and a change of approximately 2 pl (picoliter) was recorded, and hence it could be confirmed that a sufficient amount of displacement was obtained for the lens section 31 having a diameter of 3 mm.

Moreover, when the displacement of the diaphragm upon application of a 50 V, 1 ms pulse wave was measured with a laser Doppler vibrometer, a similar amount of displacement to that achieved upon application of the DC voltage described above was obtained, and there was no residual vibration. From this, it can be seen that the diaphragm deforms within 1 ms, and therefore it could be confirmed that high-speed response is possible.

### Further Action and Beneficial Effects

In the varifocal lens manufactured by means of the procedure described above, the piezoelectric element 53 contacts the oil-based liquid, and therefore the durability of the piezoelectric element is improved. If the piezoelectric body contains lead (Pb), then the lead dissolves into the water, thus causing deterioration of the element. According to the present embodiment, it is possible to prevent dissolution of lead into the water by causing the piezoelectric element 53 to make contact with the oil-based liquid, and therefore the lifespan of the piezoelectric element 53 can be increased.

### Modification Example 1

In the present embodiment, the whole of the bottom plate member 33 and the ceiling plate member 43 is made from light-transmitting members, but it is also possible to form light-transmitting window sections in portions of the bottom plate member 33 and the ceiling plate member 43. For example, it is possible to form through holes in a portion of the bottom plate member 33 and in a portion of the ceiling plate member 43, and to fill a transparent glass or a transparent resin into the portion of these through holes.

### Modification Example 2

In the embodiment described above, only one piezoelectric actuator 50 is provided inside the sealed vessel 26, but it is also possible to adopt a mode in which a plurality of piezoelectric actuators are provided. For example, by providing a plurality of diaphragm-type piezoelectric actuators in a portion of the partition plate and driving these actuators simultaneously, it is possible to obtain a larger volume change and hence to increase the range of variation of the focal length.

### Example of Application of the Varifocal Lens According to the Present Invention

A varifocal lens according to embodiments of the present invention is capable of high-speed response and has high spatial resolving power, and therefore is suitable for high-speed three-dimensional scanners and omnifocal microscope systems, and the like, and is capable of high-speed tracking of moving objects. Furthermore, by miniaturization, the lens can also be mounted in an electrical device, such as a portable telephone.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A varifocal lens which uses an interface between a first fluid and a second fluid that are mutually immiscible, as a light refracting surface, the varifocal lens comprising:
a sealed vessel in which a first chamber into which the first fluid is filled is connected via an opening to a second chamber into which the second fluid is filled; and
an elastic deformation section which is provided in elastically deformable fashion in a portion of a partition wall that divides the first chamber and the second chamber in the sealed vessel and which deforms in contact with both the first fluid filled into the first chamber and the second fluid filled into the second chamber, wherein:
a lens section having the interface is formed in the opening, and
a focal length of the lens section is changed by causing the interface to deform through altering volumes of the first chamber and the second chamber in mutually opposite directions by deformation of the elastic deformation section.

2. The varifocal lens as defined in claim 1, wherein the elastic deformation section has a composition in which a drive section producing force to deform a diaphragm provided in a portion of the partition wall is provided with the diaphragm.

3. The varifocal lens as defined in claim 2, wherein the drive section is a piezoelectric element.

4. The varifocal lens as defined in claim 3, wherein, of the first fluid and the second fluid, the fluid contacting with the piezoelectric element is an oil-based fluid.

5. The varifocal lens as defined in claim 3, wherein the diaphragm deforms due to deformation in a d31 direction of a piezoelectric body sandwiched between electrodes of the piezoelectric element.

6. The varifocal lens as defined in claim 2, wherein the diaphragm is made of silicon (Si), or a combination of silicon dioxide (SiO₂) and silicon (Si).

7. The varifocal lens as defined in claim 1, wherein the sealed vessel includes:
a first chamber structure having a first recess section forming a space of the first chamber,
a second chamber structure having a second recess section forming a space of the second chamber, and
a partition plate which has the opening and is bonded between the first chamber structure and the second chamber structure so as to cover a side of the first recess section of the first chamber structure and a side of the second recess section of the second chamber structure to serve as the partition wall.

8. The varifocal lens as defined in claim 7, wherein the elastic deformation section having a diaphragm structure is provided in a portion of the partition plate.

9. The varifocal lens as defined in claim 1, wherein the sealed vessel is provided with
an inlet port for introducing the first fluid and the second fluid into the sealed vessel,
an outlet port for discharging the first fluid and the second fluid from the sealed vessel,
a first valve which opens and closes the inlet port, and
a second valve which opens and closes the outlet port.

10. A liquid filling method for manufacturing the varifocal lens as defined in claim 9, the liquid filling method comprising the steps of:
introducing a first liquid corresponding to the first fluid into the sealed vessel via the inlet port so as to fill the first liquid into both the first chamber and the second chamber; and
discharging the first liquid via the outlet port while introducing a second liquid corresponding to the second fluid into the sealed vessel via the inlet port so as to replace the first liquid in one of the first chamber and the second chamber with the second liquid.
